(19) United States
(12) Patent Application Publication
(10) Pub. No.: US 2010/0183779 A1
(43) Pub. Date: Jul. 22, 2010

(54) METHOD AND APPARATUS FOR SANITIZING CONSUMABLE PRODUCTS USING ULTRAVIOLET LIGHT

(76) Inventor: PERRY DEAN FELIX, Houston, TX (US)

Correspondence Address: WILLIAMS, MORGAN & AMERSON, 10333 RICHMOND, SUITE 1100, HOUSTON, TX, 77042, US

(21) Appl. No.: 12/688,581

(22) Filed: Jan. 15, 2010

Related U.S. Application Data
(60) Provisional application No. 61/145,481, filed on Jan. 16, 2009.

(51) Int. Cl. A23L 3/005; A23N 15/00

(52) U.S. Cl. 426/231; 426/248; 99/451

(57) ABSTRACT

A method and apparatus are provided for sanitizing consumable products using ultraviolet light. The consumable products are exposed to the ultraviolet light for a preselected duration of time and at a desired power level to achieve a desired level of sanitization.

This application claims priority from prior co-pending U.S. Provisional Patent Application Ser. No. 61/145,481 entitled “Method and Apparatus for Sanitizing Consumable Products using an Ultraviolet Laser” filed Jan. 16, 2009.

### BACKGROUND OF THE INVENTION

1. Field of the Invention

This invention relates generally to sanitizing consumable products, and, more particularly, to sanitizing consumable products using collimated or concentrated ultraviolet light.

2. Description of the Related Art

In the course of day-to-day living, people come into contact with numerous products that have been handled or prepared in such a way that these products may have been exposed to germs, bacteria, viruses, molds, fungi, insect larvae or other undesirable and unsanitary conditions. In the course of consuming or even using these products, a person may become infected or otherwise made ill. For example, food products, such as meat, poultry, fish, cereal, water, or even air, may be inadvertently exposed to contaminated conditions.

The food industry has attempted to limit the instances of contamination by reducing the likely sources of contamination. For example, frequent cleansing of food processing equipment with sanitizing or disinfecting agents may help to limit or reduce instances of contamination. However, even an occasional failure of the cleansing process can produce widespread contamination, as evidenced by infrequent reports of food product contamination and subsequent recalls. These instances are dangerous to the public, expensive to remedy, and damaging to the reputation of the offending company. Moreover, the sanitizing agents are often ineffective and are environmentally harmful to produce, store and dispose of Consumer food products are also processed with various chemicals including fungicides and pesticides which are not earth, ozone & environmentally friendly (i.e., not green). Further, sanitizing and/or disinfecting agents are expensive, and may cause illness in the consumer and/or work force if used improperly.

### SUMMARY OF THE INVENTION

The disclosed subject matter is directed to addressing the effects of one or more of the problems set forth above. The following presents a simplified summary of the disclosed subject matter in order to provide a basic understanding of some aspects of the disclosed subject matter. This summary is not an exhaustive overview of the disclosed subject matter. It is not intended to identify key or critical elements of the disclosed subject matter or to delineate the scope of the disclosed subject matter. Its sole purpose is to present some concepts in a simplified form as a prelude to the more detailed description that is discussed later.

In one embodiment, a method is provided for sanitizing a consumable product by exposing the product to ultraviolet light.

### BRIEF DESCRIPTION OF THE DRAWINGS

The disclosed subject matter may be understood by reference to the following description taken in conjunction with the accompanying drawings, in which like reference numerals identify like elements, and in which:

FIGS. 1-5 conceptually illustrate various embodiments of the instant invention.

While the disclosed subject matter is susceptible to various modifications and alternative forms, specific embodiments thereof have been shown by way of example in the drawings and are herein described in detail. It should be understood, however, that the description herein of specific embodiments is not intended to limit the disclosed subject matter to the particular forms disclosed, but on the contrary, the intention is to cover all modifications, equivalents, and alternatives falling within the scope of the appended claims.

### DETAILED DESCRIPTION OF SPECIFIC EMBODIMENTS

Illustrative embodiments are described below. In the interest of clarity, not all features of an actual implementation are described in this specification. It will of course be appreciated that in the development of any such actual embodiment, numerous implementation-specific decisions should be made to achieve the developers' specific goals, such as compliance with system-related and business-related constraints, which will vary from one implementation to another. Moreover, it will be appreciated that such a development effort might be complex and time-consuming, but would nevertheless be a

routine undertaking for those of ordinary skill in the art having the benefit of this disclosure.

The disclosed subject matter will now be described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the disclosed subject matter. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

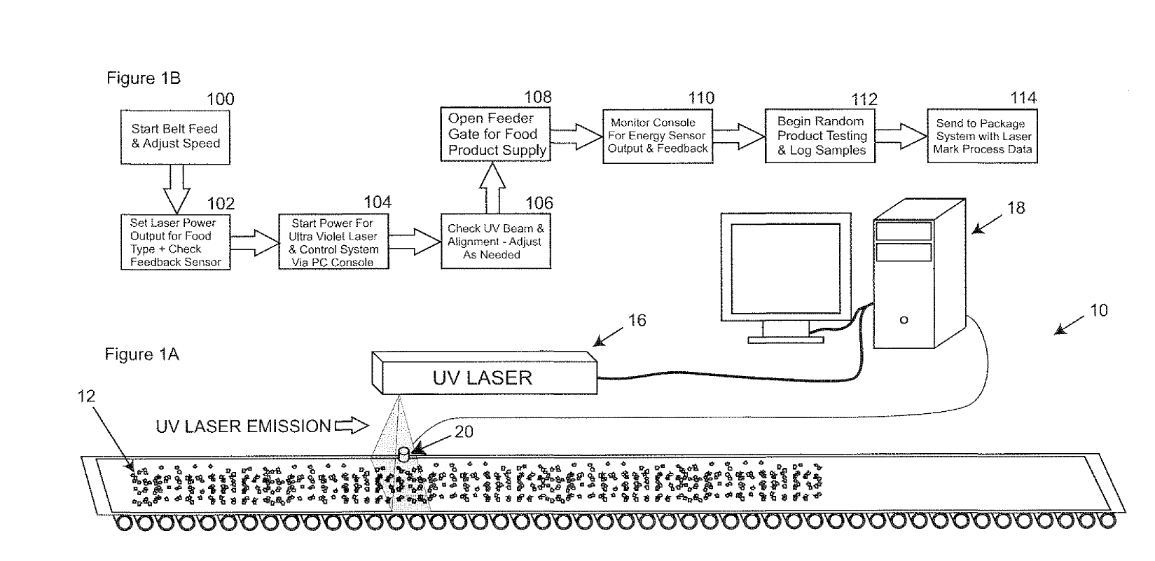

FIG. 1A conceptually illustrates a first exemplary embodiment of the instant invention. Generally, a system 10 is provided to sanitize a food product 12, such as cereal, mill, flour, rice, beans, grain, fruits, vegetables, while the food product 12 is being transported on a processing belt feed 14. The system 10 includes an ultraviolet (UV) laser operating under the control of a computer control system 18.

The UV laser 16 may take on any of a variety of forms, but generally, a common wavelength for the UV laser 16, when used in a sanitizing application, is in the range of about 266 nm to about 355 nm, which those skilled in the art will appreciate includes near UV wavelengths of about 220 nm to about 400 nm, far UV wavelengths of about 190 nm to about 220 nm, and VAC UV wavelengths of about 90 nm to about 190 nm. Depending on the area of coverage and/or belt size and application, type of product, and production flow or speed, the power of the UV laser 16 may range from as little as 2 mW to hundreds or even thousands of watts UV laser power. In one exemplary embodiment of the instant invention, a UV laser 16 operating at about 355 nm wavelength proved to be highly effective in sanitizing cereal, achieving an effective rate as high as 99.7% for killing bacteria, viruses, mold, fungi and insect larvae. In one particular embodiment, the UV laser may take the form of a diode pumped solid state laser, such as Model No. DP355 available from Han's Laser or a gas nitrogen laser such as Model No. N337 also available from Han's Laser. Those skilled in the art will appreciate that the power level of the UV laser may be adjusted to allow the UV light to penetrate into the food product so that both surface and subsurface sanitization may be effected.

The laser light may be distributed over the surface of the processing belt feed 14 using a variety of mechanical and/or optical systems. For example, a rotating or oscillating mirror may be used to reflect the laser light onto the surface of the processing belt feed 14 to create a pattern of light that effectively exposes the food product 12 to the laser light regardless of the location of the food product 12 on the processing belt feed 14. FIG. 1 A illustrates the laser light being distributed in a circular pattern for illustrative purposes only. Those skilled in the art will appreciate that the laser light could be distributed in a variety of patterns, such as square, rectangular, linear, raster scan or even random patterns in order to effectively expose the food product 12 to the laser light.

The processing belt feed 14 may take on any of a variety of forms. In one embodiment of the instant invention, it may be useful for the belt feed 14 to include at least an upper surface constructed from a material that reflects or diffracts the UV laser light. In this manner, laser light impinging upon the surface of the belt feed 14 may be reflected or bent so as to strike an otherwise unexposed surface of the food product 12 and further enhance the sanitizing effect of the UV laser light.

Further, it is anticipated that some embodiments of the invention may utilize a plurality of UV lasers 16. Moreover, when multiple UV lasers 16 are employed, they may be selected to have substantially similar or substantially different wavelengths and may be arranged in a variety of physical configurations, such as an array. The multiple UV lasers may be configured to have their output combined through prisms, fiber optic couplers, beam combiners, or the like. In some embodiments, it may be useful to provide two or more lasers irradiating the food product 12 at substantially the same location with substantially similar wavelengths to achieve higher power levels. Alternatively, in some embodiments, it may be useful to provide two or more lasers irradiating the food product 12 at different, spaced apart locations to achieve greater surface coverage. Further, some embodiments of the instant invention may utilize two or more UV lasers 16 that operate at different wavelengths to expose the food product 12 to a wider range of UV laser light in cases where the various contaminants are eradicated more effectively by different frequencies of UV laser light. It is envisioned that the multiple UV lasers may be arranged in an array.

The computer control system 18 make take on any of a variety of forms, including but not limited to conventional desktop computers, laptop computers, servers, minicomputers, controllers, and the like. The computer control system 18 may be comprised of a microprocessor, memory, a display, and input or pointing devices, such mice, keyboards, touch sensitive pads or screens and the like.

In one embodiment of the instant invention, the computer control system 18 operates to control various parameters of the system 10 to insure an effective kill rate. For example, a laser power sensor 20 may be disposed to sense actual laser power being delivered to the food product 12 on the processing belt feed 14. The laser power sensor 20 provides feedback to the computer control system 18. The computer control system 18 may then vary a signal delivered to the laser 16 to raise or lower the power of the UV laser 16, as desired. Additionally, the speed of the processing belt feed 14 may likewise be adjusted according to the actual laser power detected by the laser power sensor 20. For example, the computer control system 18 may reduce the speed of the processing belt feed 14 in response to detecting reduced UV laser power, and/or control the amount of food product being introduced onto the processing belt feed 14. Those skilled in the art will appreciate that the power level of the UV laser, the coverage area, the speed of the processing belt, and/or the density of the food product 12 on the processing belt feed 14 may be adjusted to allow the UV light to penetrate into the food product so that both surface and subsurface sanitization may be effected.

FIG. 1B illustrates an exemplary embodiment of a control sequence that may be implemented, at least partially, within the computer control system 18. The process begins at block 100 with the processing belt feed 14 starting up in preparation of transporting the food product 12 thereon. At block 102, the computer control system 18 selects or establishes a desired flow rate of the food product 12 and the speed of the processing belt feed 14. At block 104, the UV laser 16 is enabled, and various parameters of the UV laser 16 are adjusted, either manually, or by the computer control system 18 at block 106. For example, it may be useful to set the laser and optics focus adjust, aperture beam alignment, and divergence. At block 108, the computer control system 18 sets the power output control and irradiance monitor for the UV laser 16. In one embodiment of the instant invention, the irradiance monitor is a light energy sensing device. The irradiance monitor gathers light to monitor and reports light energy exposure digitally, which can be used to determine the correct balance of laser energy or to regulate output power of UV lasers in the application area.

Periodically, the computer control system 18 will receive a control signal from the laser power sensor 20, and use that signal to adjust various parameters of the UV laser 16 to achieve the desired sanitization of the food product 12. For example, at block 110 the computer control system 18 may set or adjust a pulse width, a repetition rate, and/or tune the frequency wavelength of the UV laser 16. These parameters may be adjusted as necessary to maintain a desired level of UV laser power at the processing belt feed 14.

It may also be useful to periodically test the food product 12 to determine the effectiveness of the sanitizing process. Thus, at block 112, the results of this testing may be input into the computer control system 18 and used to further control the sanitizing process. For example, if the testing indicates an undesirable level of contamination in the sanitized food products 12, then the computer control system 18 may further adjust the parameters of the system to produce a greater level of sanitization, such as by reducing the speed of the processing belt feed 14, reducing the flow rate of the food product 12, and/or increasing the power of the UV laser 16.

Additionally or alternatively, it may be useful to route the food products through one or more additional sanitizing steps, depending upon the results of the testing. For example, inadequately sanitized food products 12 may be passed through the same laser sanitizing process, or alternatively through a second similarly arranged system 10.

Those skilled in the art will appreciate that once the sanitization of the food product 12 has been completed to a satisfactory level, then the food product 12 is packaged and shipped to customers, such as is shown in block 114.

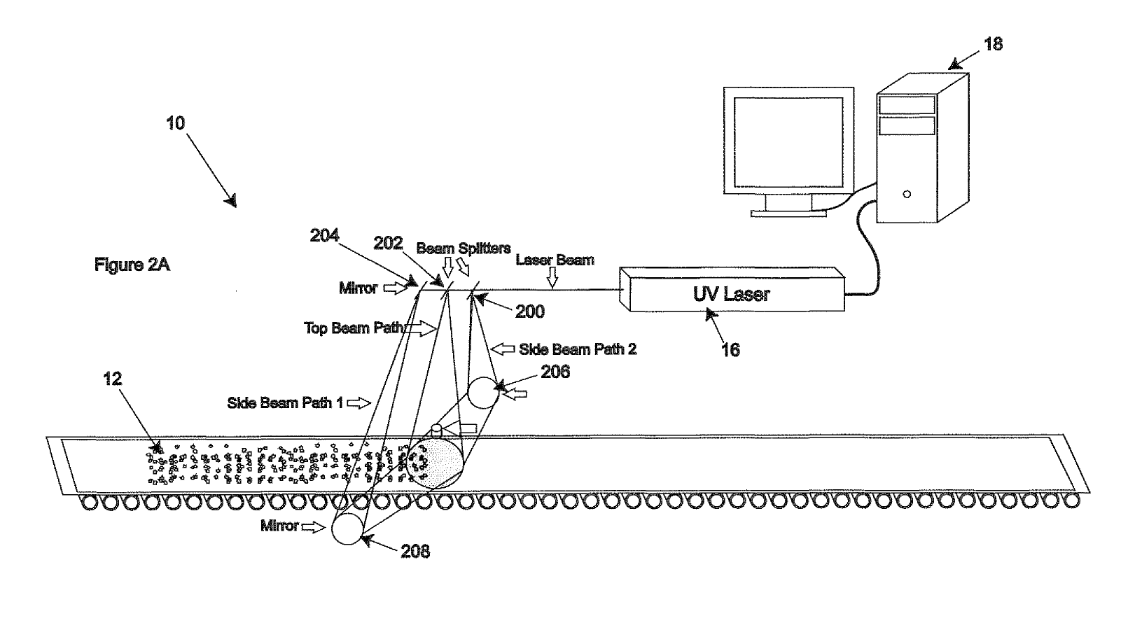

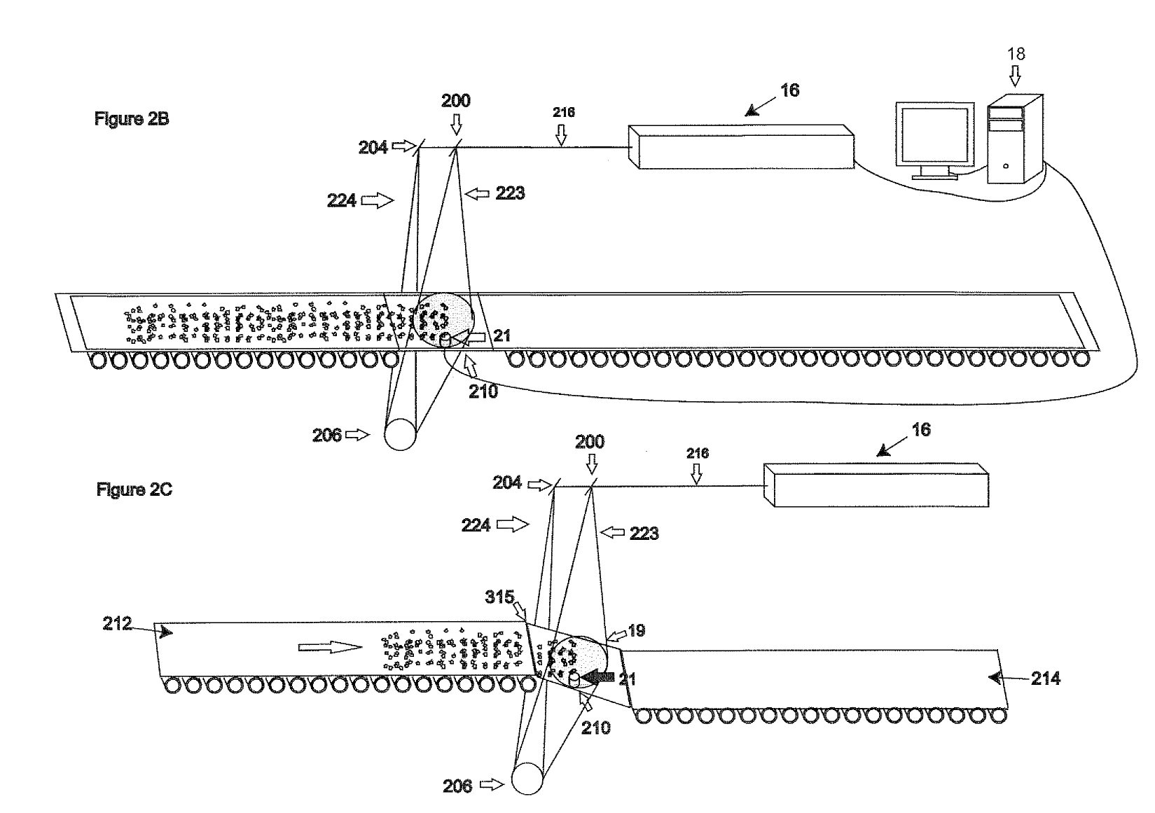

In various alternative embodiments of the instant invention, it may be useful to provide a plurality of paths for the laser light to traverse from one or more UV lasers 16 to the food product 12. In this manner, a more complete exposure of the food product 12 to the laser light may be accomplished. For example, portions of the food product 12 that may not receive direct laser light from one angle of orientation may receive it from another. For 20 example, various laser light paths may be accomplished by routing the laser light through flexible fiber optic links. Alternatively, turning first to FIG. 2A, the laser 16 projects laser light through a one or more beam splitters 200, 202 to produce a plurality of beams of laser light. These beams of laser light may be redirected by optical devices, such as mirrors 204, 206,208 so as to impinge upon the food product 12 from a variety of different angles. In the 25 illustrated embodiment, two beam splitters 200, 202 and three mirrors 204, 206, 208 are arranged to provide three different laser light paths to the food product 12—a top beam path and two side beam paths. Each of these paths of light may impinge upon portions of the food product 12 not illuminated by the other paths. In this manner, the food product is more effectively sanitized.

FIGS. 2B and 2C illustrate alternative embodiments of the instant invention in which multiple laser light paths are used to sanitize the food product 12. In these embodiments of the instant invention, at least a portion of the processing belt feed 14 is comprised of a material that will allow UV laser light to pass therethrough. Multiple laser light paths are produced in a manner substantially similar to that described above in conjunction with FIG. 2A using the beam splitter 200 and mirrors 204, 206. In this embodiment, however, one laser light path is directed to a top surface of the processing belt feed 14, while a second laser light path is direct to a bottom surface of the processing belt feed 14. In the embodiment of the instant invention shown in FIG. 2B, the first laser light path sanitizes the top portions of the food product 12, and the second laser light path passes through the transparent/translucent processing belt feed 14 to impinge upon the bottom portions of the food products 12. In this manner, both the top and bottom surfaces of the food product are exposed to the sanitizing effect of the UV laser light.

Alternatively, in the embodiment of the instant invention shown in FIG. 2C, the processing belt feed 14 is comprised of a transparent/translucent slide 210. The second laser light path passes from below the slide 210 to illuminate the bottom surfaces of the food product 12. The orientation of the slide 210 takes advantage of the effects of momentum and gravity to move the food product between powered processing belt feeds 212, 214.

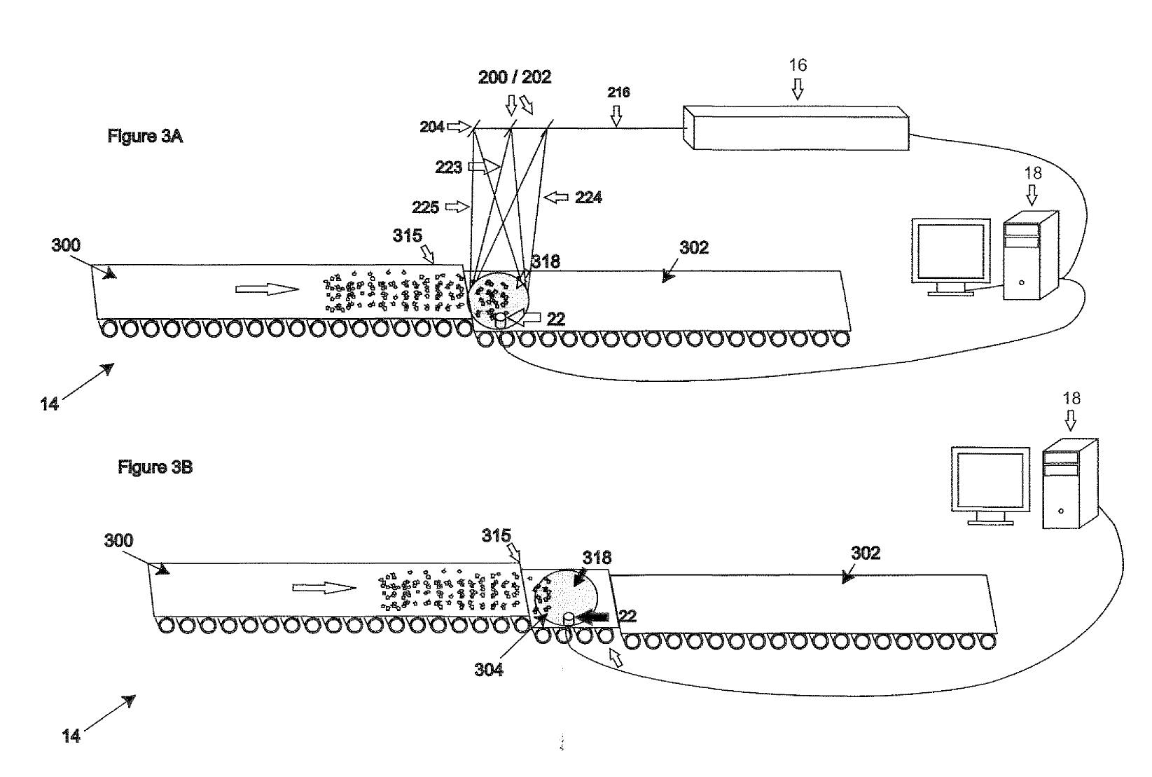

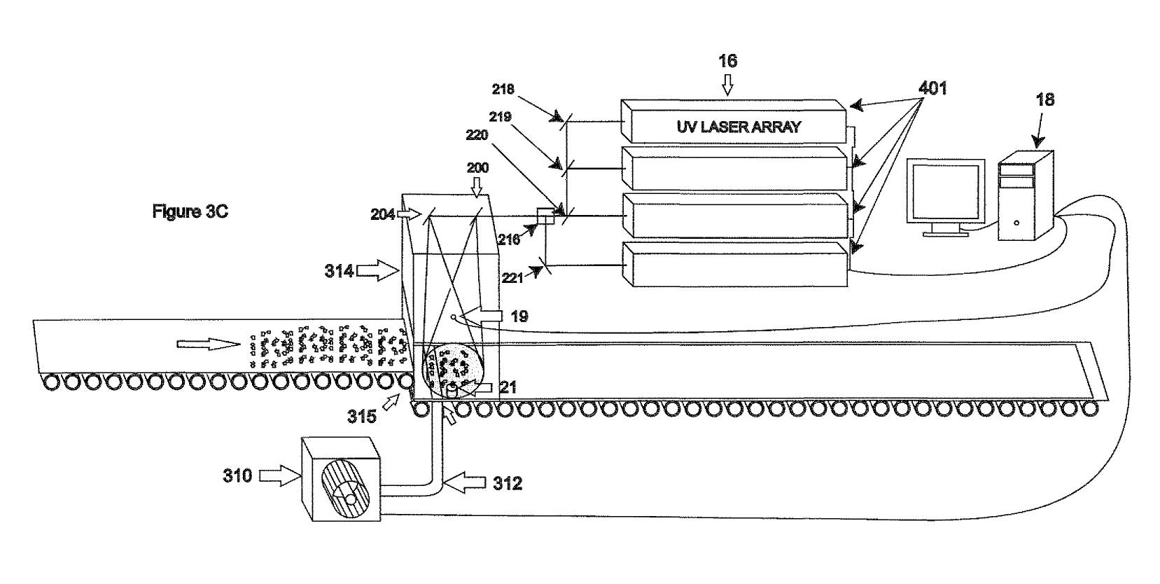

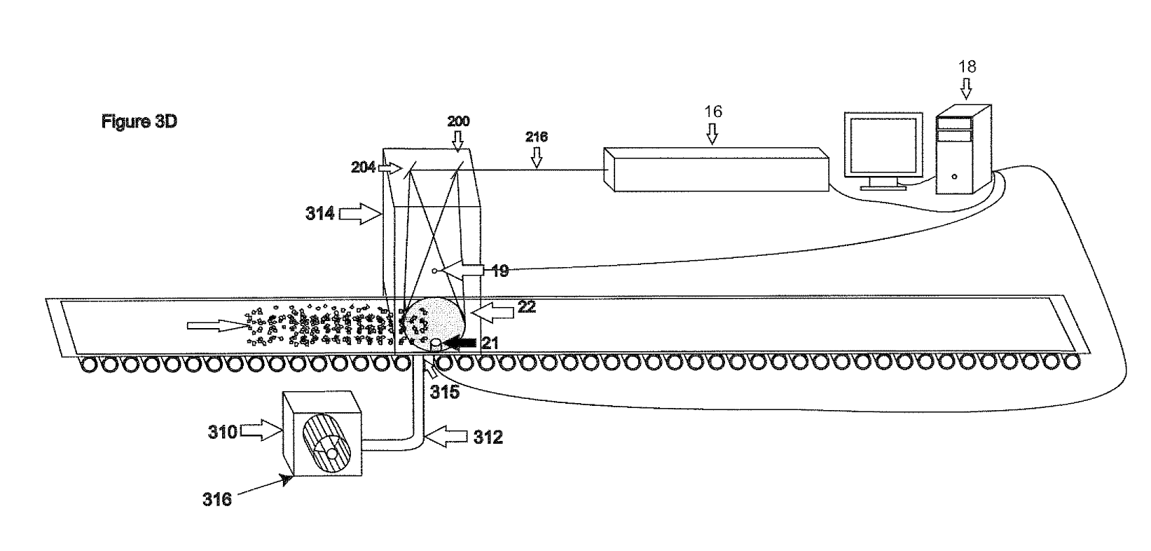

In various alternative embodiments of the instant invention, it may be useful to disturb the food product 12 on the processing belt feed 14 to insure that all surfaces of the food product 12 are exposed to the UV laser light. Turning now to FIG. 3A, a first embodiment of a system that disturbs or reorients the food product 12 on the processing belt feed 14 is described. In the illustrated embodiment, the processing belt feed 14 is comprised of two or more belt feeds 300, 302 positioned at different vertical heights. In this manner, food product 12 reaching the end of the first belt feed 300 falls to the surface of the vertically lower belt feed 302. In the process of falling, the food product 12 becomes reoriented, exposing previously hidden surfaces. In the illustrated embodiment, the UV laser light is directed onto the food product in a region adjacent the intersection of the upper and lower belt feeds 300, 302. In some embodiments of the instant invention it may be useful to orient the laser light to overlap both the upper and lower belt feeds 300, 302 so that the laser light may impinge upon the food product in its original position on the upper belt feed 300 and upon the food product's reoriented position on the lower belt feed 302. The laser light may also be allowed to impinge upon the food product 12 as it falls between the upper and lower belt feeds 302 so as to fall upon multiple surfaces as the food product 12 tumbles through the air. Those skilled in the art will appreciate that it may be useful to combine the various embodiments described herein to enhance the sanitizing effect of the UV laser light. In particular, FIG. 3B illustrates a UV laser light system that includes the drop mechanism discussed in conjunction with FIG. 3A above and a reflective or diffractive surface 304 on at least a portion of the belt feed 14.

Turning now to FIG. 3C, an alternative embodiment of the instant invention is shown. In particular, an alternative mechanism for disturbing or reorienting the food product 12 is described. In this embodiment of the instant invention, a blower 310 with an associated vent or duct work 312 is positioned to disturb the food product 12. In one embodiment of the instant invention, it may be useful to provide an enclosure 314. The enclosure 314 may be useful to retain the food product 12 and prevent it from being scattered off of the belt feed 14. The enclosure 314 may also be useful to shield and retain the UV laser light within a limited area. Those skilled in the art will appreciate that the volume of air introduced into the enclosure 314 may be controlled to produce limited movement of the product 12, or alternatively, or enhanced to produce exaggerated movement of the food product 12, such as by keeping the food product 12 airborne and tumbling for a desired period of time such that all surfaces of the food product 12 are completely and repeatedly exposed to the UV laser light.

In some embodiments of the instant invention, it may be useful to provide multiple UV laser light paths within the enclosure 314 to ensure a complete and thorough exposure of the food product 12 to the UV laser light. Moreover, in the illustrated embodiment of the instant invention, the UV laser light is provided by an array of UV lasers 401. The UV laser light from the array of UV lasers 401 may be directed and/or combined by a plurality of optical and/or mechanical elements, such as mirrors/beam combiners 218, 219, 220, prisms 216, mirrors 221, and the like to produce one or more beams of UV laser light traveling on one or more paths within the enclosure 314.

Turning now to FIG. 3D, an alternative embodiment of the instant invention is shown in which an alternative mechanism for disturbing or reorienting the food product 12 is described. In this embodiment of the instant invention, a vibrator 316 is coupled to the belt feed 14 so as to disturb or reorient the food product 12. Vibrations from the vibrator 316 are transferred to the belt feed 14 by conventional mechanical interconnections such that the belt feed 14 is oscillated, thereby disturbing or reorienting the food product 12 to expose additional surfaces of the food product 12 to the UV laser light.

Turning now to FIG. 4, an alternative embodiment of the instant invention is illustrated. In this embodiment of the instant invention, a UV light source 400 is positioned to provide UV light onto a belt feed 14 that includes a consumable product, such as the food product 12, distributed thereon. Generally, the UV light source 400 may be comprised of a UV light panel 402 and a lens panel 404, as shown in FIG. 4A. The UV light panel 402 may take the form of one or more UV Vertical Cavity Surface Emitting Lasers (VCSELs), UV Verical Light Emitting Diode (VLEDs), UV Edge Emitting Lasers (EELs), UV plasma, UV phosphorus tape, and the like. The lens panel 404 may be comprised of a Fresnel lens 406, a micro lens array 408, or the like, as shown in FIG. 4B.

Those skilled in the art will appreciate that the UV light panel 402 and lens panel 404 may be configured to be readily removed and replaced so that the makeup of the UV light source 400 may be configured to suit the particular application. That is, different combinations of UV light panels 402 and lens panels 404 may be better suited to different types of food products 12. Accordingly, in some embodiments of the instant invention, it may be useful to include a housing that the UV light panels 402 and lens panels 404 that slidingly engage to allow ready removal and insertion of the desired type of UV light panel 402 and lens panel 404. Moreover, it may be useful to provide multiple sliding locations within the housing so that the UV light panel 402 and lens panel 404 may be positioned at a variety of vertical locations suited to the particular combination of UV light panel 402 and lens panel 404, as well as the particular food product 12.

Further, depending on the food product 12 being sanitized, it may be useful to disturb the food product 12 to allow a more complete exposure of the food product 12 to the sanitizing UV light produced by the UV light source 400. Accordingly, any of the methodologies discussed above may be employed to disturb the food product 12. For example, an elevated belt drop 412 may be used to disturb the position of the food product on the belt feed 14. Additionally, it may be useful to disturb the food product 12 by coupling an air blower 414 through air ducts 416 to an area adjacent the belt feed 14. As discussed in embodiments of the invention described above, blowing air may be used to disturb the food product 12 for a more thorough exposure to the sanitizing UV light.

As with the embodiments discussed above, the computer control system 18 may be used to control the intensity of the UV light delivered to the food product 12, the speed of the belt feed 14, the coverage area, the density of the food product 12 on the processing belt feed 14 or other parameters to effectively control the level of sanitization of the food product 12. Moreover, these parameters may be adjusted to allow the UV light to penetrate into the food product 12 so that both surface and subsurface sanitization may be effected. As with the embodiments discussed above, various sensors may be employed to detect the intensity of the UV light being delivered to the food product 12 and/or a sensor may be used to detect the actual level of sanitization of the food product 12. Using feedback from these sensors, the computer control system 18 may adjust the speed of the belt feed, the level of power applied to the UV light source 400, and/or a combination thereof to produce the desired level of sanitization.

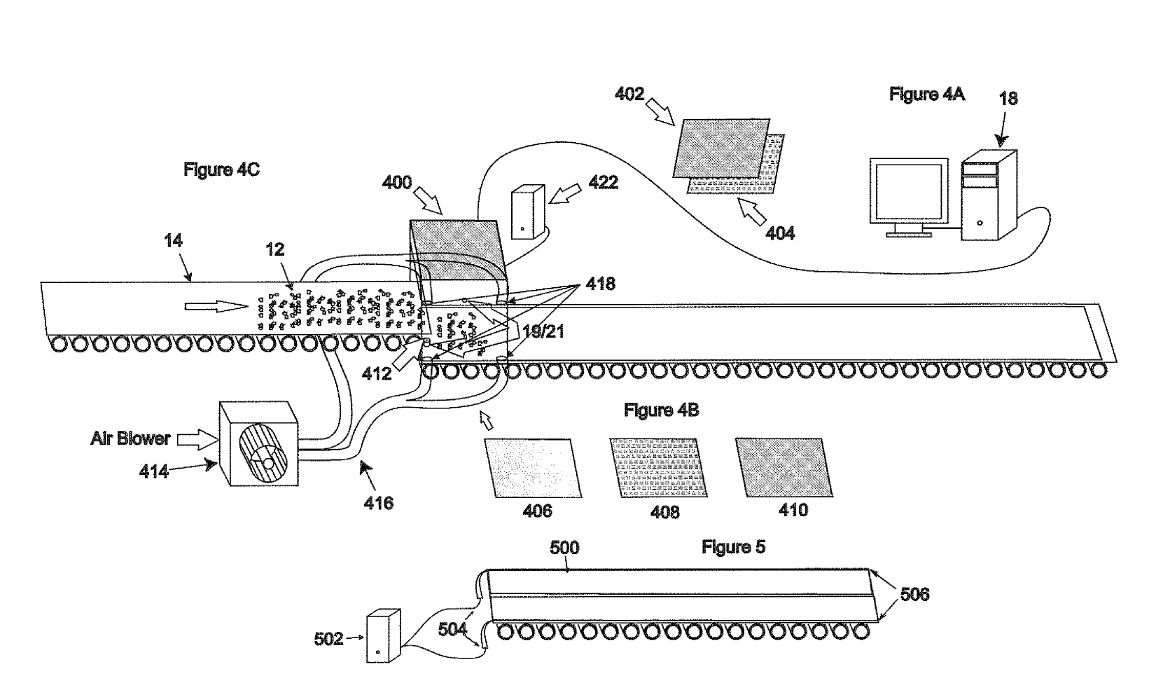

Turning now to FIG. 5, the belt feed 14 may take on any of a variety of forms. In one embodiment of the instant invention, it may be useful for the belt feed 14 to include at least an upper surface constructed from a material that emits UV light. For example, the belt feed 14 may have one or more strips of UV phosphorus material 500 attached to or formed into the belt feed 14. The belt feed may be comprised of a translucent, transparent, or clear material, such as silicon, neoprene, rubber, flexible plastic, or the like with the strip of UV phosphorus material formed therein and arranged to emit UV light from the upper surface of the belt feed 14 onto the food product 12 located thereabove. In this manner, the bottom surface of the food product 12 may be exposed to the sanitizing UV light.

Power may be supplied to the UV phosphorus material 500 from a controllable power supply 502 via various conventional electrical connections, such as one or more brushes 504 contacting one or more metallic strips 506 located on or adjacent the strip of UV phosphorus material 500. Those skilled in the art will appreciate that the UV phosphorous material 500 could be powered by a variety of methods that do not require an external, hardwired connection. For example, contactless connections could be provided to transfer power to the UV phosphorous material 500, such as an inductive link, a capacitive link, a photovoltaic link, or the like. Additionally, in an alternative embodiment, batteries may be deployed on the belt feed 14 to supply power to the UV phosphorous material 500. In an embodiment that includes batteries, it may be useful to also employ a contactless connection to provide periodic or continuous charging for the batteries. The computer control system 18 may adjust the level of power supplied by the controllable power supply 502 to provide a desired level of sanitization of the food product 12.

Portions of the disclosed subject matter and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the

discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the disclosed subject matter are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The disclosed subject matter is not limited by these aspects of any given implementation.

The particular embodiments disclosed above are illustrative only, as the disclosed subject matter may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed:

1. A method for sanitizing consumable products, the method comprising:
exposing the consumable product to ultraviolet light.

2. A method, as set forth in claim 1, further comprising exposing the consumable product to ultraviolet light from a plurality of sources.

3. A method, as set forth in claim 1, further comprising exposing the consumable product to ultraviolet light traveling along a plurality of predefined paths.

4. A method, as set forth in claim 1, further comprising exposing the consumable product to ultraviolet laser light.

5. A method, as set forth in claim 1, further comprising exposing the consumable product to ultraviolet light in the frequency of about 266 nm to about 400 nm.

6. A method, as set forth in claim 1, further comprising disturbing the consumable product during a time period related to the exposure of the consumable product to ultraviolet light.

7. A method, as set forth in claim 5, wherein disturbing the consumable product during the time period related to the exposure of the consumable product to ultraviolet light further comprises disturbing the consumable product while the consumable product is being exposed to ultraviolet light.

8. A method, as set forth in claim 5, wherein disturbing the consumable product during the time period related to the exposure of the consumable product to ultraviolet light further comprises disturbing the consumable product between multiple exposures of the consumable product to ultraviolet light.

9. A method, as set forth in claim 1, further comprising measuring a parameter of the ultraviolet light being delivered to the consumable product and adjusting an aspect of the ultraviolet light being delivered to the consumable product.

10. A method, as set forth in claim 8, wherein measuring the parameter of the ultraviolet light being delivered to the consumable product and adjusting the aspect of the ultraviolet light being delivered to the consumable product further comprises measuring the intensity of the ultraviolet light being delivered to the consumable product and adjusting the power level of an ultraviolet light source used to deliver the ultraviolet let to the consumable product.

11. A method, as set forth in claim 1, further comprising determining a level of sanitization of the consumable product and adjusting an aspect of the ultraviolet light being delivered to the consumable product based on the determined level of sanitization.

12. A method, as set forth in claim 10, wherein determining the level of sanitization of the consumable product and adjusting the aspect of the ultraviolet light being delivered to the consumable product based on the determined level of sanitization further comprises determining the level of sanitization of the consumable product and increasing the intensity of the ultraviolet light being delivered to the consumable product based on the determined level of sanitization being less than a preselected setpoint.

13. An apparatus for sanitizing consumable products, the apparatus comprising:
an ultraviolet light source; and
means for transmitting ultraviolet light from the ultraviolet light source to a consumable product.

14. An apparatus, as set forth in claim 12, wherein the means for transmitting ultraviolet light from the ultraviolet light source to the consumable product further comprises a plurality of optical paths between the ultraviolet light source and the consumable product.

15. An apparatus, as set forth in claim 12, wherein the means for transmitting ultraviolet light from the ultraviolet light source to the consumable product further comprises optical fibers.

16. An apparatus, as set forth in claim 12, wherein the ultraviolet light source comprises a plurality of ultraviolet light sources.

17. An apparatus, as set forth in claim 12, wherein the ultraviolet light source comprises an ultraviolet laser.

18. An apparatus, as set forth in claim 12, wherein the ultraviolet light source comprises an ultraviolet laser capable of producing ultraviolet light in a range of about 266 nm to about 400 nm.

19. An apparatus, as set forth in claim 12, further comprising a transport mechanism for moving the consumable product through a region exposed to the ultraviolet light produced by the ultraviolet light source.

20. An apparatus, as set forth in claim 18, wherein the transport mechanism further comprises a belt feed with the consumable product distributed thereon and oriented to pass through at least one region exposed to the ultraviolet light.

21. An apparatus, as set forth in claim 19, further comprising means for disturbing the consumable product in the at least one region exposed to the ultraviolet light.
